(19) United States
(12) Patent Application Publication
(10) Pub. No.: US 2003/0066356 A1
(43) Pub. Date: Apr. 10, 2003

(54) Fiber-optic device for measuring stresses

(76) Inventors: Vasilios Kanellopoulos, Troinex (CH); Jean-Francois Ricard, La-Chaud-de-Fonds (CH); George Kotrotsios, Etoy (CH)

Correspondence Address: HENDERSON & STURM LLP, 1213 MIDLAND BUILDING, 206 SIXTH AVENUE, DES MOINES, IA, 50309-4076, US

(21) Appl. No.: 10/229,482

(22) Filed: Aug. 28, 2002

Related U.S. Application Data
(63) Continuation of application No. PCT/CH00/00127, filed on Mar. 6, 2000.

(51) Int. Cl. G01L 1/24

(52) U.S. Cl. 73/800

(57) ABSTRACT

The invention concerns a device comprising at least a transducer (1) in the form of a matrix wherein is embedded an optical fiber segment (7) provided with means designed to modify light transmission in accordance to a stress to be measured. One input end of said optical fiber (7) is designed to be connected to an optical transmitter (8) and one output end to an optical detector (9). The transducer (1) is elongated in shape, longitudinally run through by said optical fiber segment (7). A median section (2) is designed to be subjected to stresses to be measured, its two ends being respectively secured to two portions transmitting stresses (3, 4) to said median section (2), arranged to be attached to the structure to be measured Said matrix is made of a composite material reinforced with filaments to provide the transducer (1) with a modulus of elasticity close to that of the structure to be measured.

The present invention relates to a fiber-optic device for measuring stresses, which comprises at least one transducer formed from a matrix through which at least one segment of optical fiber passes, this being conformed so that the transmission of light is modified according to a stress to be measured, said stress being transmitted by said matrix to said optical fiber, an input end of this optical fiber also being intended to be connected to a photoemitter and an output end to a photoreceiver.

There are already a number of strain gages coupled to one or more optical fibers conformed so as to produce a modification in the light transmitted through the fiber according to the stress to which this fiber is subjected.

A system has been proposed in EP 0 640 824 for detecting cracks in a structure, comprising a plurality of optical fibers fixed, parallel to each other, to a support which is itself fixed to the structure to be examined. A Bragg grating can be placed along the fiber in order to measure stresses. In this case, the optical fibers do not form an integral part of the measurement support but are fixed to the surface of this support. Furthermore, this support does not constitute a strain gage whose definition properties are known, but a simple interface between the fiber and the structure to be measured. In this case it is used to detect the presence of cracks and not to measure the magnitude of a stress.

In the case of WO 97/15805, an optical fiber which includes a Bragg grating is wound around two studs extending perpendicular to a support plate which can be welded to a metal structure whose stresses it is wished to measure. The stresses in the structure are communicated to the support for the studs, varying their separation and consequently the tension exerted on the fiber, so that the Bragg grating makes it possible to vary the wavelength of the light transmitted along the optical fiber according to the magnitude of the stress.

The measurement made using this probe depends on the winding tension of the optical fiber, which is liable to vary depending on the weather and on the temperature in particular, so that such a probe must be periodically calibrated. Given that several tens or even hundreds of probes may be needed to monitor a structure, such as a bridge, a dam, an aircraft wing, steam generators of power stations and in general any civil engineering structures, such work to calibrate each probe is virtually impossible to envision.

U.S. Pat. No. 5,594,919 relates to a method of fixing an optical fiber, for measuring stress, to a metal structure, in which the fiber is metallized and fixed to a metal support block by brazing or welding and this support is itself fixed by welding to the metal structure to be measured. The complexity of this fixing method makes such a probe expensive to manufacture.

EP 0 357 253 relates to a fiber-optic detector in which the optical fiber is embedded in a chosen matrix in order to undergo a deformation depending on a parameter to be measured. This deformation is transmitted to the optical fiber, modifying the properties of light propagation through this fiber and making it possible to obtain the quantity of the parameter as a function of the measured stress. The matrix must therefore be made of a material capable of undergoing a transformation in the presence of the parameter to be measured. In this case it is therefore not a strain gage, the stress being a characteristic quantity of the parameter to be measured and not the parameter to be measured itself.

Most of the abovementioned solutions do not relate to strain gages and especially to a strain gage coupling an optical measurement fiber to a composite matrix. The only document in which the optical fiber is embedded in a matrix for measuring a stress, the stress is characteristic of another parameter to be measured, so that it is not a strain gage but a gage in which the matrix is designed to transform a certain physical quantity to be measured into a stress proportional to this physical quantity.

A fiber-optic strain gage has been well described in EP 0 380 764. In this case, the optical fiber is not embedded in a matrix and the solution in question requires mounting and adjustment operations which increase the cost of the instrument. In addition, the optical fiber is protected and may be subject to influences, or even degradation, liable to have an impact on the result of the measurement.

The object of the present invention is to remedy, at least in part, the drawbacks of the abovementioned solutions.

For this purpose, the subject of the present invention is a fiber-optic transducer for measuring stresses, as defined in claim 1.

Various complementary features and variants of this gage are defined in the other claims.

The strain gage according to the invention has specific characteristics, which are known and perfectly reproducible from one gage to another. These characteristics, in particular the elastic modulus may furthermore be adapted according to the structure in which it is desired to measure the stresses. Once the optical fiber has been incorporated into the composite forming the transducer of the gage, it behaves as an element of the matrix itself. In addition, this matrix fulfills the role of protecting the fiber from undesirable external attack or influences.

No calibration is needed, the characteristics of the gage being chosen according to the composite used; it may be fixed or integrated into any structure, the measured values being those of the stresses in this structure.

The appended drawing illustrates, schematically and by way of example, two embodiments of the fiber-optic transducer for measuring stresses, the subject matter of the present invention.

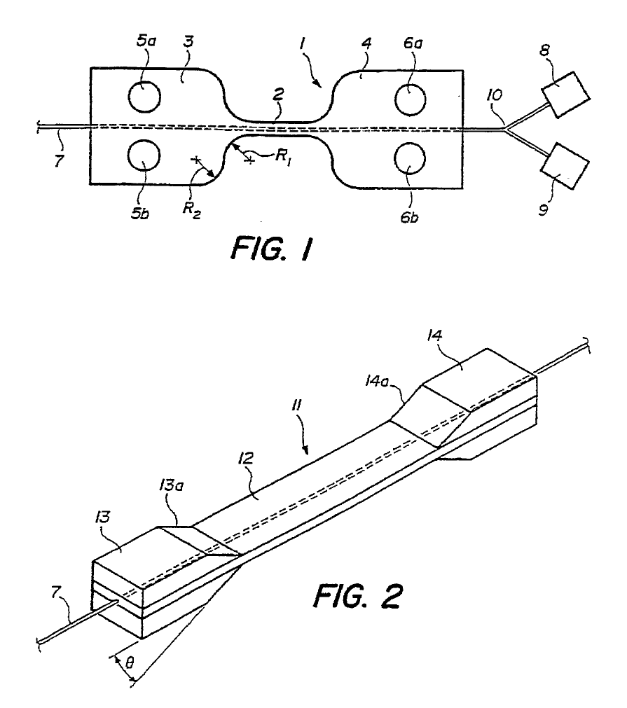

FIG. 1 is a plan view of the first embodiment.

FIG. 2 is a perspective view of the second embodiment.

The transducer according to the first embodiment is in the form of an elongate transducer 1 of constant thickness made of a composite, forming a strain gage, comprising a central part 2 of constant cross section intended for measuring the stresses, the two ends of which are integral with stress transmission parts 3, 4 which are conformed in order to connect this gage to the structure in which it is desired to measure the stress. Each of these stress transmission parts has an enlarged part connected to the central part 2 by radii of curvature R₁, R₂. These stress transmission parts 3, 4, which serve to transmit the stresses from the structure to the central part 2, each have two openings 5a, 5b and 6a, 6b respectively, which occupy relative positions symmetrical with respect to the longitudinal axis of the elongate transducer 1. These openings are used for fixing the stress transmission parts 3, 4 to the structure to be monitored, which structure must therefore be provided with tenons that can fit into the openings 5a, 5b, 6a, 6b, bolts being able to make it possible to guarantee that the transducer is fixed to the structure to be measured.

An optical fiber 7 passes longitudinally through the elongate transducer 1. One of its ends is intended to be connected to a photoemitter 8 while the other is connected to a photoreceiver 9. Depending on the measurement device used, the light may be reflected, partly or completely, so that the photoemitter 8 and the photoreceiver 9 may then be at one and the same end of the optical fiber 7, as illustrated in FIG. 1, this end of the optical fiber 7 then having the shape of a Y, 10, to allow the same end of the optical fiber 7 to be connected to the emitter 8 and to the receiver 9, in a manner well known to those skilled in the art. The segment of the optical fiber 7 which passes through the central part 2 of the transducer 1 of the strain gage has, for example, a Bragg grating intended to selectively reflect a defined wavelength, the latter varying depending on the strain in the optical fiber 7 subjected to the stress to be measured. The wavelength of the reflected light, compared with that of the incident light, allows the value of this stress to be determined. Other light measurement principles could also be used, such as interferometry.

The transducer 1 made of a composite of the according to the invention is formed by a stack of sheets of a resin intended to constitute the matrix, embedded in which sheets are plies of straight reinforcing filaments placed parallel to one another. In this example, the resin is PEEK and the reinforcing filaments are filaments having a high elastic modulus, especially carbon fibers, aramid fibers or even glass fibers. The choice of the filaments and their proportion in the matrix depend on the desired elastic modulus of the transducer 1.

According to one embodiment example, PEEK sheets reinforced with reinforcing filaments are cut to the shape of the transducer 1. Certain of these sheets are cut so that the reinforcing filaments are placed parallel to the longitudinal axis of the transducer 1, others with the reinforcing filaments extending perpendicular to this longitudinal axis. According to a variant, the sheets could be cut to the shape of the transducer after having been stacked.

These sheets are then stacked in a mold formed from two parts, one the upper part and the other the lower part, having the same shape as the transducer 1 if the sheets have been precut to the shape of the transducer, otherwise the mold will have the same rectangular shape as that of the sheets. Advantageously, an aluminum foil intended to facilitate demolding may be laid on each face of the stack. The lower part of the mold is firstly placed in a vice. An agent intended to facilitate demolding is sprayed onto the surface of the mold and an aluminum foil is laid thereon, the demolding agent being sprayed onto the surface of said aluminum foil.

In the example which follows, eight precut composite sheets were stacked, the sheets in which the filaments make an angle of 0° with the longitudinal axis alternating with those in which they make an angle of 90° with this longitudinal axis, in the following manner: one 0°-filament-orientation sheet, one 90°-filament-orientation sheet, two 0°-orientation-sheets, one 902-orientation sheet, three 0°-orientation sheets.

The optical fiber 7 is then placed along the longitudinal axis, that is to say well centered with respect to the width of the transducer, with its Bragg grating centered longitudinally with respect to the central part 2 of the transducer 1. A weight is attached at each end of this optical fiber 7 in order to ensure that it is really straight and the stacking of the precut composite sheets is continued, by placing in succession three 0°-orientation sheets, one 90°-orientation sheet, two 0°-orientation sheets, one 90°-orientation sheet and one 0°-orientation sheet. Finally, the second aluminum foil is laid thereon, the demolding agent being sprayed on the surface of which foil and possibly being sprayed onto the surface of the upper part of the mold.

The bolts serving to grips the two parts of the mold against each other are then tightened, by successively tightening two M10 bolts lying along one diagonal of the mold, then two other M10 bolts lying along the other diagonal of the mold and the two M10 bolts lying symmetrically with respect to the longitudinal axis of the transducer 1, along a perpendicular passing through the center of this longitudinal axis. These bolts are tightened to a torque of 4 N.m using a torque wrench.

The mold is then heated for 10 min at 400° .C and the bolts are retightened to a torque of 4 N.m. The temperature is maintained at 400° C. for a further 25 min and the bolts of the mold are tightened to a torque of 5 N.m. The heating temperature is again maintained for 25 min and the whole assembly is left to cool down before demolding.

In the example described, the transducer 1 has a thickness of around 2.2 mm, a length of 120 mm, the length of the central part 2 being 20 mm and its width 5 mm, the radii R₁ and R₂ are each 10 mm and the width of the stress transmission parts 3, 4 is 24 mm.

As a variant, the composite used may also be a composite reinforced by a mixture of high-elastic-modulus filaments, of the type mentioned above, and of metal filaments, so as to allow the transducer to be welded to the structure to be monitored.

According to another variant, it is possible to choose the components involved in the composition of the composite and their proportions so as to obtain a composite whose thermal coefficient is close to zero, so as to compensate the effects of temperature variation which modify the behavior of the Bragg grating. This therefore allows a self-compensating transducer to be obtained.

The transducer according to the first embodiment illustrated in FIG. 1 is more particularly intended to be fixed to the surface of a structure to be monitored because of its constant thickness and of the openings 5a, 5b, 6a, 6b intended to allow the transducer to be fixed to the structure to be monitored.

The second embodiment, illustrated in FIG. 2, is, on the other hand, designed more especially to be able to be embedded in a structure, in particular in a concrete structure. The transducer 11 is of constant width, the central stress measurement part 12 consists of a blade and the stress transmission parts 13, 14 are, in this case, thicker than the central part 12, the additional thickness being distributed approximately symmetrically on either side of the blade of the central part. The internal transverse face, 13a, 14a respectively, of each stress transmission part 13, 14 makes an angle θ of between 6° and 30°, preferably between 6° and 15°. The optical fiber 7 passes approximately along the longitudinal axis of the transducer 11 and a Bragg grating is centered in the middle of the length of the stress measurement part 12.

As in the previous embodiment, the transducer 11 is made of a composite reinforced with high-elastic-modulus filaments. In this example, the strain gage has a length of 640 mm, the central parts 12 having a length of 320 mm. The width of this transducer 11 is 80 mm. The thickness of the central part 12 is 2 to 2.5 mm and that of the stress transmission parts 13, 14 between 6 and 7 mm.

The advantage of this embodiment resides in the fact that it does not require the structure to be provided with fixing means, since all that is required is to embed the transducer in the structure to be monitored. However, this advantage is limited in practice to concrete structures under construction, whereas the first embodiment may be fixed to whatever structure, and to existing concrete structures.

Hitherto, embodiments have been described in which an optical fiber 7 passes through a transducer. Of course, it is obvious to a person skilled in the art that the same optical fiber may include several Bragg gratings for different wavelengths, the gratings being distributed at defined distances along this optical fiber, each of these gratings being coupled to a transducer 1 or 11, the signals reflected by each Bragg grating being multiplexed by the photoreceiver 9. Thanks to this arrangement, it is possible typically to measure the signals from 10 to 20 transducers with the same measurement apparatus and to differentiate the results thanks to the multiplexing, thus making it possible to determine the value of the stress registered by each transducer. The number of transducers and the spacing between them may be adapted according to the structure to be monitored.

In such a case, it is very important to reduce as far as possible the losses induced by the microbends communicated through the optical fiber. To reduce these microbends as far as possible, a certain tension is exerted on the optical fiber 7 by fixing a weight at each of its ends in order to keep it as straight as possible. However, it has been observed that this is insufficient and it has been found that microbends are produced by the reinforcing fibers embedded in the matrix of the composite.

This is because, as was mentioned in the previous example, the matrix of the transducer 1 or 11 is formed from sheets of continuous parallel reinforcing filaments coated with the resin of the matrix, the orientations of these reinforcing filaments being fcrossed at angles of 90°. However, as may be realized in this example, the closer one approaches the optical fiber the greater the number of layers with reinforcing filaments oriented parallel to the fiber. It has in fact been demonstrated that by increasing the proportion of layers having reinforcing filaments parallel to the optical fiber 7 in the immediate vicinity of the latter the microbends in this optical fiber are reduced and, by the same token, the losses are reduced, thereby making it possible to increase the number of transducers that can be placed along one and the same optical fiber.

As a variant, it is also possible to use interferometry to perform the stress measurement. In this case, the interference between the light signals traveling along the two optical fibers, one subjected to the stress to be measured and the other a reference optical fiber, is measured.

Finally, two optical fibers could also pass through the same transducer, the said optical fibers lying on either side of the neutral fiber of the transducer, in order to measure a compressive force with the aid of one of them and a tensile force with the other.

1. A fiber-optic device for measuring stresses, which comprises at least one transducer (1; 11) formed from a matrix through which at least one segment of optical fiber (7) passes, conformed so that the transmission of light is modified depending on a stress to be measured, said stress being transmitted by said matrix to said optical fiber (7), an input end of this optical fiber (7) being intended to be connected to a photoemitter (8) and an output end to a photoreceiver (9), characterized in that said transducer (1; 11) is of elongate shape, through which said segment of optical fiber (7) passes longitudinally and that it includes a central portion (2; 12) intended to be subjected to the stresses to be measured, its two ends being integral respectively with two parts (3, 4; 13, 14) for transmitting the stresses to said central portion (2; 12), having means (5a, 5b, 6a, 6b; 13a, 14a) for fastening them to the structure to be measured, and in that said matrix is made of a composite reinforced with filaments in order to give said transducer (1; 11) an elastic modulus similar to that of the structure to be measured.

2. The device as claimed in claim 1, characterized in that said transducer (1) has an approximately constant thickness, said optical fiber (7) passing through this transducer (1; 11) approximately in the middle of its thickness and of its width.

3. The device as claimed in one of the preceding claims, characterized in that said reinforcing filaments are high-elastic-modulus filaments.

4. The device as claimed in one of the preceding claims, characterized in that said reinforcing filaments are distributed in the form of parallel layers of filaments, some oriented longitudinally and some transversely to said transducer.

5. The device as claimed in claim 4, characterized in that the layers of composite which are adjacent to said optical fiber (7) have reinforcing filaments oriented parallel to this optical fiber (7) and in that the number either of successive layers or the thickness of the latter in which the reinforcing filaments are oriented parallel to this optical fiber (7) progressively increases as said optical fiber (7) is approached.

6. The device as claimed in one of the preceding claims, characterized in that said means for modifying the transmission of light through said optical fiber are formed by a Bragg grating.

7. The device as claimed in claim 6, characterized in that the thermal coefficient of said matrix is chosen close to zero so as to compensate for the effects of temperature variations on the Bragg grating.

8. The device as claimed in one of the preceding claims, characterized in that metal is incorporated into said matrix in the vicinity of at least one of its external faces, in order to allow said transducer (1; 11) to be soldered to a metal structure.

8. The device as claimed in one of claims 1 and 3 to 8, characterized in that said stress transmission parts (13, 14) each have two additional thicknesses on each side of a blade (12) extending over the length of said transducer (11), the internal transverse face (13a, 14a) of each additional thickness making an angle (θ) of between 6° and 30° with the respective faces of said blade (12).

10. The device as claimed in one of the preceding claims, characterized in that a plurality of transducers are coupled to one and the same optical fiber, the respective segments of the fiber which are coupled to said plurality of transducers each having a Bragg grating reflecting a different wavelength, said photoreceiver (9) including means for multiplexing the reflected signals.
